(19) United States
(12) Patent Application Publication
(10) Pub. No.: US 2008/0086899 A1
(43) Pub. Date: Apr. 17, 2008

(54) Razor head and method for making the same

(76) Inventor: Richard N. Gallagher, Phoenix, AZ (US)

Correspondence Address: TOD R NISSLE, PO BOX 55630, PHOENIX, AZ, 85078, US

(21) Appl. No.: 11/580,268

(22) Filed: Oct. 12, 2006

(51) Int. Cl. B26B 21/40; B26B 21/00

(52) U.S. Cl. 30/526; 30/32

(57) ABSTRACT

A metal razor head assembly includes a hollow unitary skeleton with at least one detent, an insert positioned in the skeleton and including a metal finger shaped to be bent to interlock with the detent, and a tool inserted in the razor head to bend the finger to interlock with the detent.

This invention relates to razors.

More particularly, the invention relates to a razor that utilizes disposable razor blade cartridges of the type marketed by Gillette™ and Shick™, which cartridges include one or more razor blades embedded in plastic. The cartridges are slid, snapped, or otherwise removably mounted on the head of a razor handle.

In a further respect, the invention relates to an improved method for making a razor head that is adapted to receive a disposable razor blade cartridge.

A conventional razor handle 10 and head are illustrated in FIGS. 1 to 3. The head removably receives a Gillette disposable razor blade cartridge. The blade cartridge unit is not shown, but typically includes two or three spaced apart, parallel blades embedded in plastic in the manner found in most current day disposable blade cartridges or disposable razors.

The razor head in FIG. 1 includes a hollow metal skeleton 12 shaped to receive a first plastic insert 13 and a second plastic insert 14. Insert 13 snaps into aperture 17 of skeleton 12 in the direction of arrow D; after which insert 14 snaps into skeleton 12 in the direction of arrow E.

Inserts 13 and 14 are made from plastic and each include substantially rigid arms. The arms are provided with outwardly extending teeth or lips, and can be resiliently displaceable so that the arms, when being inserted in skeleton 12, are initially inwardly bent by sliding over inner surfaces in the skeleton and then resiliently return to their original position when teeth on the arms are in registration with and snap into detents or around edges formed in skeleton 12. In particular, arms 22 and 23 of insert 14 comprise such resilient substantially rigid arms.

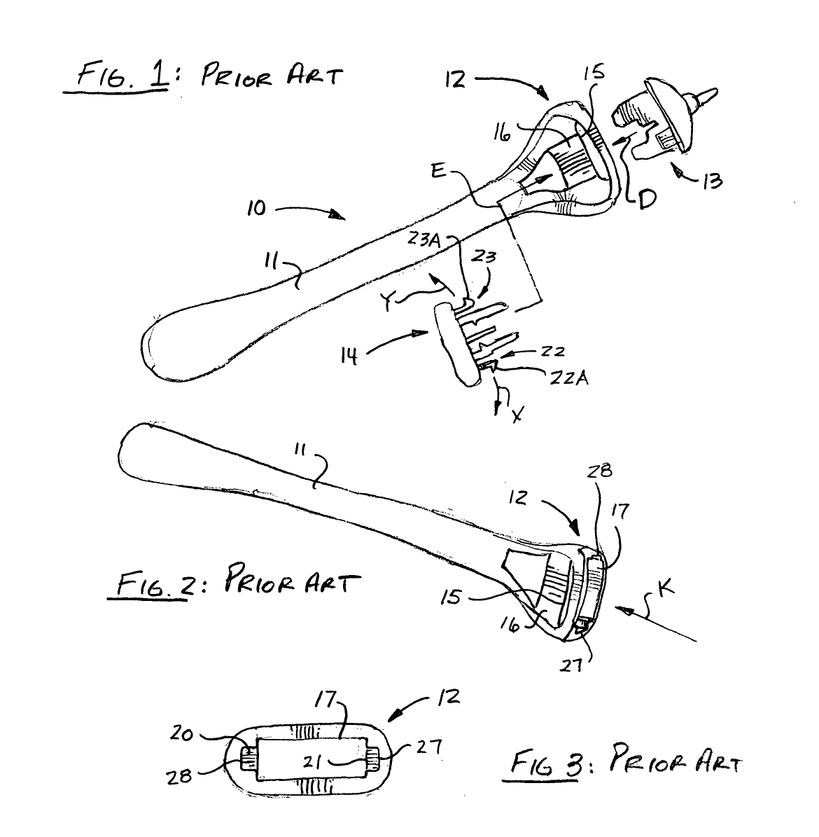

Detents, or ledges, 20 and 21 are formed inside skeleton 12 at the bottom of grooves 28 and 27, respectively. Detents 20 and 21 are not visible in FIG. 1, but can be seen in FIG. 3. Grooves 27 and 28 are visible in FIGS. 2 and 3. Detents 20 and 21 are shaped to receive teeth 23A and 22A, respectively, of resilient arms 23 and 22.

When plastic insert 14 is inserted in skeleton 12 in the direction of arrow E, arms 22 and 23 slide over inner surfaces of skeleton 12 and are resiliently deflected inwardly (from their normal position shown in FIG. 1) toward one another and then, when teeth 22A and 23A reach and are in registration with detents 21 and 20, respectively, arms 22 and 23 resiliently spring or snap outwardly in the direction of arrows X and Y so that teeth 22A and 23A seat in detents 21 and 20 and lock insert 14 in skeleton 12.

Since multiple components are used to produce the razor head of FIGS. 1 to 3, and since the plastic components tend to have a limited lifetime, it would be desirable to simplify the razor head and to improve the construction of the razor head to extend the operational life and structural strength of the razor head.

Therefore, it is a principal object of the invention to provide an improved razor head.

Another object of the invention is to provide an improved method for constructing a razor head from metal or another material that has greater damage resistance and structural integrity than molded polymer components.

These and other, further and more specific objects and advantages of the invention will be apparent to those of skill in the art from the following detailed description thereof, taken in conjunction with the drawings, in which:

FIG. 1 is an exploded view illustrating a prior art razor handle and head;

FIG. 2 is a side-top view of the razor handle and razor head skeleton of FIG. 1 illustrating further construction details thereof;

FIG. 3 is a side view of the portion of the razor head skeleton of FIG. 2 looking from the direction of arrow K and illustrating further construction details thereof;

FIG. 4 is an exploded assembly view illustrating the razor head assembly of the invention;

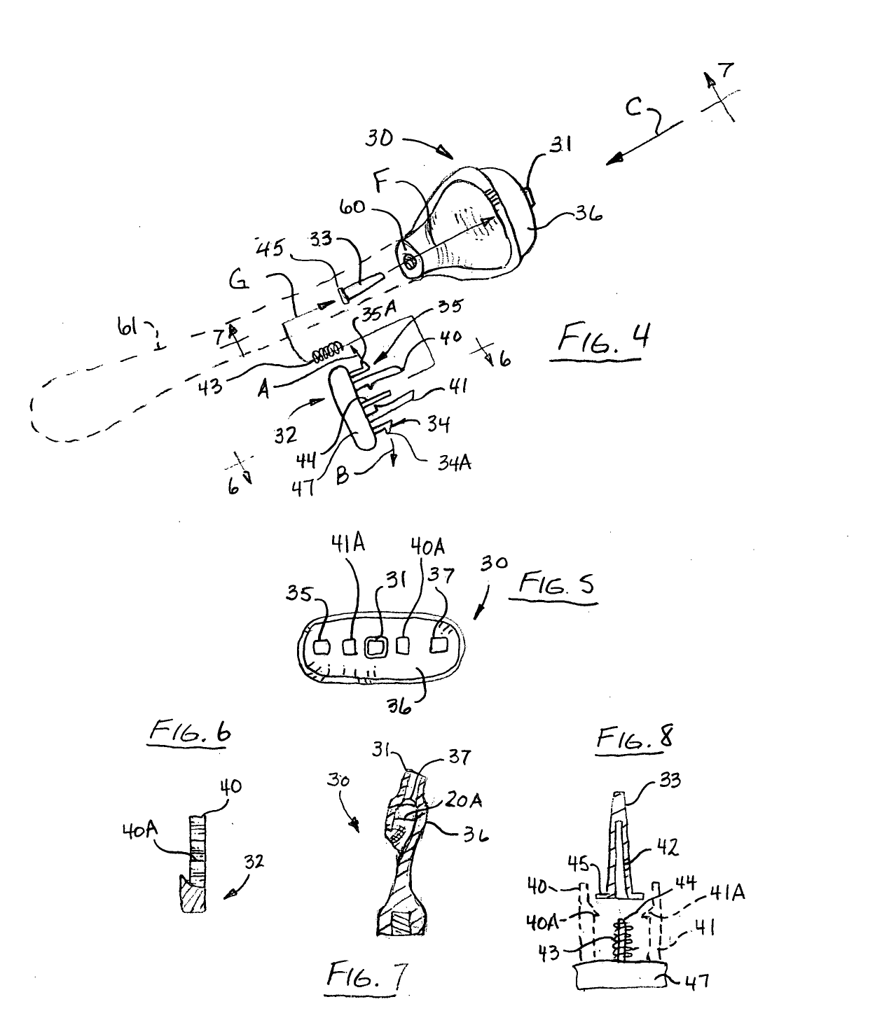

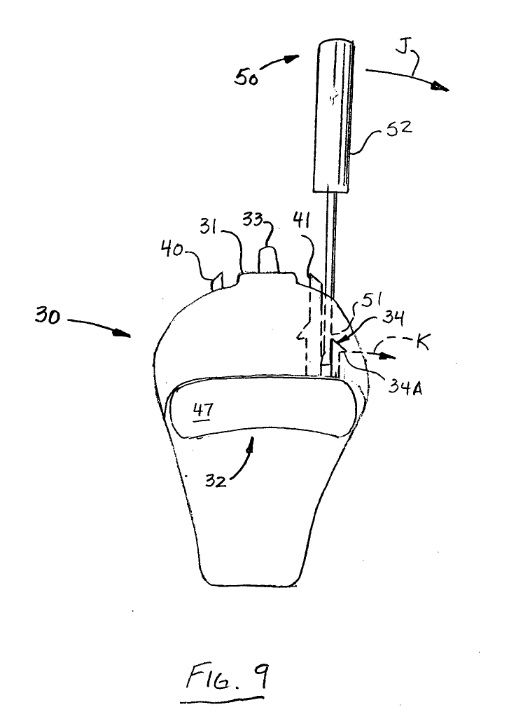

FIG. 5 is a top view illustrating the razor head skeleton of FIG. 4 viewed from the direction indicating by arrow C;

FIG. 6 is a section view illustrating insert 32 of FIG. 4 and taken along section line 6-6 thereof;

FIG. 7 is a section view of another portion of the razor head of FIG. 4 taken along section line 7-7 thereof;

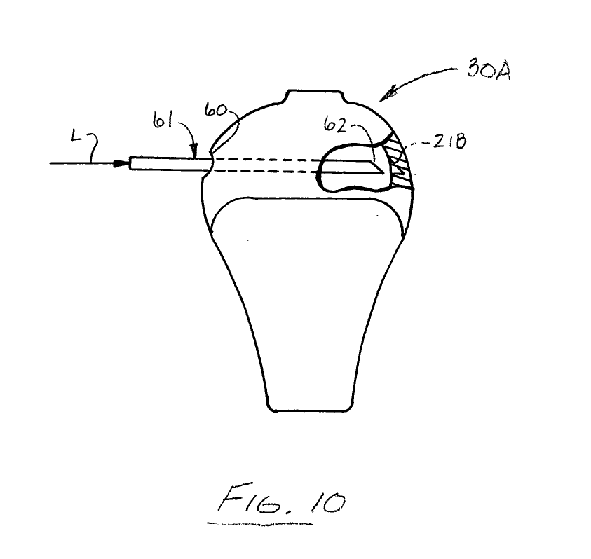

FIG. 8 is an exploded view of a portion of the razor head of FIG. 4;

FIG. 9 is a front view of the assembled razor head of FIG. 4 illustrating the tool utilized to secure the razor head in its assembled configuration;

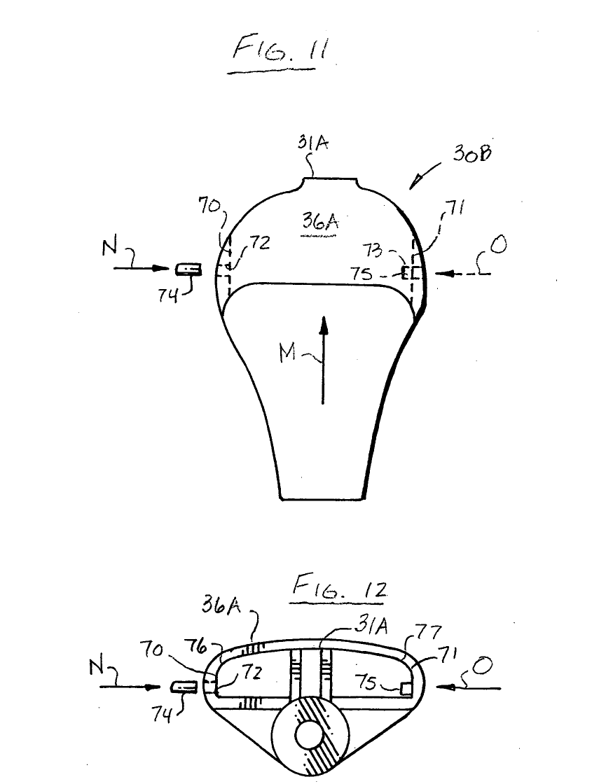

FIG. 10 is a front partial section view of a razor head skeleton illustrating an alternate method of manufacturing the same;

FIG. 11 is a front view of a razor head skeleton illustrating an alternate method of manufacturing the same; and,

FIG. 12 is a bottom view of the razor head skeleton of FIG. 11 illustrating further construction details thereof.

Briefly, in accordance with the invention, I provide an improved razor head assembly. The assembly comprises a tooth member; a substantially rigid metal insert comprising a base, at least one guide member extending outwardly from the base, at least one arm including a tooth and extending outwardly from the base; a hollow unitary skeleton including a first aperture slidably receiving the tooth member, a second aperture slidably receiving the guide member, a third tool access aperture, and a detent engaging the tooth; and, a tool including a handle extending outside the third aperture, an intermediate portion extending through the third aperture, and a working end adjacent and contacting the arm.

In another embodiment of the invention, I provide an improved method to make a razor head assembly. The method comprises the steps of providing a tooth member; of providing a substantially rigid metal insert comprising a base, at least one guide member extending outwardly from the base, at least one arm including a tooth and extending outwardly from the base; and, of providing a hollow unitary skeleton. The skeleton includes a first aperture to slidably receive the tooth member, a second aperture to slidably receive the guide member, a third tool access aperture, and a detent to engage the tooth. The method also includes the steps of providing a tool including a handle, and a working end shaped to extend through the tool access aperture to a position adjacent the arm such that the tool can be manipulated to bend the arm; of mounting the insert in the skeleton; of inserting the working end in the third aperture to position the working end adjacent the arm; and, of manipulating the tool to bend the arm such that the tooth engages the detent to maintain the insert in the skeleton.

In a further embodiment of the invention, I provide an improve method to make a razor head assembly. The method comprises the steps of providing a tooth member; providing a substantially rigid insert comprising a base, at least one guide member extending outwardly from the base, and at least one arm including a tooth and extending outwardly from the base; providing a hollow unitary skeleton including a first aperture to slidably receive the tooth member, a second aperture to slidably receive said guide member, a detent to engage the tooth; and, inserting the tooth and insert in said skeleton such that the tooth engages the detent.

Turning now the drawings, which depict the presently preferred embodiments of the invention for the purpose of illustration thereof, and not by way of limitation of the invention, and in which like characters refer to corresponding elements throughout the several views, the razor head assembly of the invention is illustrated in FIGS. 4 to 9. The razor head assembly includes hollow skeleton 30, tooth 33, spring 43, and insert 32. Insert 32 is molded from metal. Skeleton 30, tooth 33, and spring 43 are also preferably, but not necessarily, molded or otherwise fabricated from metal.

Any desired method and apparatus can be utilized to secure the razor head assembly to a razor handle 61. One presently preferred method is to form an internally threaded aperture 60 in skeleton 30. Aperture 60 turns onto an externally threaded screw (not shown) extending from one end of handle 61.

The razor head assembly of FIGS. 4 to 9 will, like the conventional razor head of FIG. 1, removably receive a disposable Gillette razor blade cartridge or other desired razor blade cartridge.

Molded metal skeleton 30 combines into a single metal piece the metal skeleton 12 and plastic insert 13 of the prior art razor head of FIG. 1. The tip of metal tooth 33 is slidably inserted in aperture 31 in skeleton 30 in the direction of arrow F (FIG. 4). The lower lip 45 (FIGS. 4, 8) of tooth 33 is too wide to fit into aperture 31. As shown in FIG. 8, an aperture 42 extends upwardly from the bottom of tooth 33 and into tooth 33. Aperture 42 is shaped to slidably receive finger 44 of insert 32. Spring 43 also fits over finger 44 and is compressed between the lip 45 of tooth 33 and base 47 of insert 32. When the razor head assembly is assembled in the manner illustrated in FIG. 9, spring 43 functions to press tooth 33 into aperture 31 such that the tip of tooth 33 extends outwardly from skeleton 30 in the manner illustrated in FIG. 9. Spring 43 can not completely push tooth 33 outer through aperture 31 because while the tip of tooth 33 will slidably fit through aperture 31, the lip 45 of tooth 33 is too large to fit through aperture 31. As will be described, teeth 40A and 41A (FIG. 8) also limit the travel of tooth 33. When the razor head assembly is assembled as shown in FIG. 9, spring 43 is not fully compressed. As a result, the tip of tooth 33 can be pushed downwardly toward skeleton 30 to displace tooth 33 toward base 47. This biased functioning of the tooth 33 permits, when a Gillette razor cartridge is mounted on the razor head of FIG. 9, a pivoting portion of the cartridge to contact the tip of tooth 33 such that biased tooth 33 provides a limited amount of resistance when said pivoting portion pivots.

Insert 32 includes base 47. Metal fingers 34 and 35 extend outwardly from base 47, along with elongate guide members 40 and 41 and finger 44. Inwardly extending teeth 40A and 41A (FIG. 8) of guide members 40 and 41 function to capture lip 45 of tooth 33 intermediate base 47 and tooth pair 40A and 41A and to prevent lip 45 from moving upwardly away from base 47 and past teeth 40A and 41A.

Metal finger 34 can be bent outwardly in the direction of arrow B (FIG. 4) and includes outwardly projecting tooth 34A. Tooth 34A, as explained below, engages and interlocks with a detent or ledge 21A in hollow skeleton 30 to prevent insert 32 from being removed from skeleton 30 once insert 32 is slidably inserted in skeleton 30 to the position illustrated in FIG. 9.

Metal finger 35 can be bent outwardly in the direction of arrow A (FIG. 4) and includes outwardly projecting tooth 35A. Tooth 35A, as explained below, engages and interlocks with a detent or lip 20A (FIG. 7) formed in hollow skeleton 30 to prevent insert 32 from being removed from skeleton 30 once insert 32 is slidably inserted in skeleton 30 to the position illustrated in FIG. 9.

Hollow unitary skeleton 30 is depicted in FIGS. 4, 5, 7, and 9. FIG. 5 illustrates apertures 35, 37, 40A, 41A, and 31 formed and extending through the top 36 of skeleton 30. In FIG. 7, aperture 31 extends from the hollow interior of skeleton 30 outwardly through top 36. Apertures 35, 37, 40A, 41A similarly extend from the hollow interior of skeleton 30 outwardly through top 36. When insert 32 is slid into skeleton 30 to the position illustrated in FIG. 9, guide member 40 extends through aperture 40A such that the distal tip of member 40 is, as can be seen in FIG. 9, visible. Similarly, when insert 32 is slid into skeleton 30 to the position illustrated in FIG. 9, guide member 41 extends through aperture 41A such that the distal tip of member 41 is, as can be seen in FIG. 9, visible.

Skeleton 30 includes opposing, spaced apart detents 20A and 21A comparable in shape and dimension to the opposing, spaced apart detents 20 and 21 formed in the razor head of FIG. 1. Detent 21A is not visible in FIGS. 4 to 9. Detent 20A can, however, be seen in FIG. 7. Detents 20A and 21A are intended to receive and interlock with teeth 35A and 34A just as detents 20 and 21 in skeleton 12 receive and interlock with teeth 23A and 22A. The problem with accomplishing this in the razor head assembly of FIGS. 4 to 9 is that fingers 34 and 35, even though they can be bent, are both substantially rigid and not elastic. Consequently, if fingers 34 and 35 are slidably deflected inwardly by surfaces in skeleton 30 when inset 32 is slid into skeleton, fingers 34 and 35 are permanently bent and do not spring outwardly so teeth 34A and 35A will seat in detents 21A and 20A, respectively, when teeth 34A and 35A are in registration with detents 21A and 20A. Accordingly, skeleton 30 preferably is shaped and dimensioned such that inner surfaces of skeleton 30 do not, when insert 32 is slid into skeleton 30 to the position illustrated in FIG. 9, bend fingers 34 and 35 from the position shown in FIG. 4; although, it would be possible to inwardly bend fingers 34 and 35 and then use a tool 50 to bend fingers 34 and 35 outwardly in the manner described below.

After insert 32 is slid into skeleton 30 to the position shown in FIG. 9, the working end 51 of a tool 50 is slid through aperture 35 to the position illustrated in FIG. 9. Handle 52 is manipulated in the direction of arrow J to bend finger 34 outwardly in the direction of arrow K to seat tooth 43A in adjacent detent 21A (not visible). Moving handle 52 in the direction of arrow J bends finger 34 in the direction of arrow K because working end 51 is anchored against the bottom of guide member 41. Member 41 does not bend, or give. Finger 34 bends. Tool 50 can be constructed and manipulated in any desired manner as long as tool 50, when inserted in the razor head assembly and manipulated, bends finger 34 to seat tooth 34A in detent 21A to prevent insert 32 from being removed from skeleton 30. The shape and dimension of handle 52 can be varied as desired. For example, either end of a convention Allen wrench can typically function as a handle when the other end is inserted in the head of a bolt.

After insert 32 is slid into skeleton 30 to the position shown in FIG. 9, the working end 51 of tool 50 is, in the manner described above for finger 34, slid through aperture 37 and manipulated to bend finger 35 such that tooth 35A seats in detent 20A.

FIG. 10 illustrates an alternate construction and method of manufacturing razor head skeleton 30. The skeleton 30A in FIG. 10 is substantially identical to skeleton 30, except that when skeleton is initially molded from metal or another material, (1) skeleton 30A includes a tool access aperture 60 formed in a side of skeleton 30A, (2) skeleton 30A includes a companion tool access aperture comparable to aperture 60 formed in the opposing side of skeleton 30A (not shown in FIG. 10), and, (3) detents comparable to detents 20A and 21A are not formed in the inner surfaces of skeleton 30A. Detents 20B and 21 B comparable to detents 20A and 21A are formed by utilizing punch tool 61. Tool 61 is slidably inserted through aperture 60 in the manner shown in FIG. 10, and is driven in the direction of arrow L such that tip 62 forms a detent 21B at the desired location in the inner surface of skeleton 30A. An opposing detent 20 is formed in the inner surface on the opposite side of skeleton 30A by similarly inserting tool 61 through an aperture formed in skeleton 30A and driving tip 62 into said opposing inner surface. As would be appreciated by those of skill in the art, aperture 60 and its opposing companion aperture are formed through skeleton 30A at locations other than locations at which detents 20B and 21B are to be formed. Aperture 60 and its companion opposing aperture can be formed during molding of skeleton 30A, or, can be formed with a drill or other tool subsequent to the molding of skeleton 30A. Tool 61 can be utilized during the molding process to form detents 21B and 20B, possibly while the material used to form skeleton 30A is relatively soft and has not fully hardened or cured.

Alternatively, aperture 60 and its companion tool access aperture can be formed through the side of skeleton 30A at locations at which detents 20B and 21B would normally be formed such that the portions of aperture 60 and its companion aperture that are near the inner surfaces of skeleton 30A effectively function as detents 20B and 21B and receive teeth 35A and 34A, respectively.

Yet another method of manufacturing skeleton 30 comprises using an insert molding process in which portions of skeleton 30 comprising and defining detents 20A and 21A are placed in a mold such that said portions (1) are contacted by metal or another mold material injected or otherwise placed in the mold, and (2) become part of the completed skeleton 30. This insert molding process avoids having to form and product detents 20A and 21A after skeleton 30 is molded.

Insert 32 can be formed in whole or in part from a polymer or other material that produces bendable resilient legs 34 and 35 comparable to resilient arms 22 and 23 of insert 14.

FIGS. 11 and 12 illustrate an alternate construction and method of manufacturing razor head skeleton 30. The skeleton 30B in FIGS. 11 and 12 is substantially identical to skeleton 30, except that, (1) in skeleton 30B openings 35 and 41A are combined into a single opening 70, (2) in skeleton 30B openings 37 and 40A are combined into a single opening 77, and (3) in skeleton 30B cylindrical apertures 72 and 73 are formed through side walls 70 and 71, respectively, to receive pins 74 and 75, respectively. Apertures 72 and 73 can be formed in skeleton 30B when skeleton 30B is molded or after skeleton 30B is molded or otherwise manufactured. Apertures 72 and 73 can be formed such that pins 74 and 75 are secured therein with adhesive, by welding, etc.; or, apertures 72 and 73 can be formed such that pins 74 and 75 are force fit into said apertures in the direction of arrows N and 0. In FIGS. 11 and 12, pin 75 has been force fit or otherwise secured in aperture 73 such that the inner end of pin 75 extends inwardly and outwardly from wall 71. This inner end functions as a detent in the same manner as detent 21 and receives, “catches”, and interlocks with tooth 34A when insert 32 is slid into and seats in skeleton 30B in the direction of arrow M and either (1) finger 34 resiliently snaps tooth 34A onto the inner end of pin 75, or (2) a tool 50 is used to bend finger 34 such that tooth 34A engages (i.e., extends over) the inner end of pin 75. When tooth 34A engages the inner end of pin 75, insert 32 can not be pulled out of skeleton 30B in a direction opposite that of arrow M.

When pin 74 is secured in aperture 72, the inner end of pin 74 extends outwardly from wall 70 and, when insert 32 is slid into and seats in skeleton 30B in the direction of arrow M, the inner end of pin 74 functions like detent 20 and receives, “catches”, and interlocks with tooth 35B of finger 35. E.g., the inner end of pin 74 functions with respect to finger 35 and tooth 35A in the same manner as the inner end of pin 75 functions with respect to finger 34 and tooth 34A.

If desired, pins 74 and 75 can be inserted in skeleton 30B after insert 32 is slid in the direction of arrow M into skeleton 30B and seats in skeleton 30B in the same manner that insert 32 seats in skeleton 30 in FIG. 9. If pins 74 and 75 are inserted in this fashion, insert 32 can not be removed from skeleton 30B because teeth 35A and 34A engage and “catch” the inner ends of pins 74 and 75, respectively.

Having described the presently preferred embodiments and best mode of the invention in such terms as to enable those of skill in the art to understand and practice the invention, I claim:

1. A razor head assembly comprising
(a) a tooth member;
(b) a substantially rigid metal insert comprising
(i) a base,
(ii) at least one guide member extending outwardly from said base, and
(iii) at least one arm including a tooth and extending outwardly from said base;
(c) a hollow unitary skeleton including
(i) a first aperture slidably receiving said tooth member,
(ii) a second aperture slidably receiving said guide member,
(iii) a third tool access aperture, and
(iv) a detent engaging said tooth; and,
(d) a tool including
(i) a handle extending outside said third aperture,
(ii) an intermediate portion extending through said third aperture, and
(iii) a working end adjacent and contacting said arm.

2. A method to make a razor head assembly comprising the steps of
(a) providing a tooth member;
(b) providing a substantially rigid metal insert comprising
(i) a base,
(ii) at least one guide member extending outwardly from said base,
(iii) at least one arm including a tooth and extending outwardly from said base;
(c) providing a hollow unitary skeleton including
(i) a first aperture to slidably receive said tooth member,
(ii) a second aperture to slidably receive said guide member,
(iii) a third tool access aperture,
(iv) a detent to engage said tooth;
(d) providing a tool including
(i) a handle,
(ii) a working end shaped to extend through said tool access aperture to a position adjacent said arm such that said tool can be manipulated to bend said arm;
(e) mounting said insert in said skeleton;
(f) inserting said working end in said third aperture to position said working end adjacent said arm; and,
(g) manipulating said tool to bend said arm such that said tooth engages said detent to maintain said insert in said skeleton.

3. A method to make a razor head assembly comprising the steps of
(a) providing a tooth member;
(b) providing a substantially rigid insert comprising
(i) a base,
(ii) at least one guide member extending outwardly from said base,
(iii) at least one arm including a tooth and extending outwardly from said base;
(c) providing a hollow unitary skeleton including
(i) a first aperture to slidably receive said tooth member,
(ii) a second aperture to slidably receive said guide member,
(iii) a detent to engage said tooth; and,
(d) inserting said tooth and insert in said skeleton such that said tooth engages said detent.
